(19) United States
(12) Patent Application Publication
(10) Pub. No.: US 2019/0000059 A1
(43) Pub. Date: Jan. 3, 2019

(54) Automated Multispectral Detection, Identification and Remediation of Pests and Disease Vectors

(71) Applicants: Szabolcs Marka, New York, NY (US); Imre Bartos, New York, NY (US); Zsuzsanna Marka, New York, NY (US)

(72) Inventors: Szabolcs Marka, New York, NY (US); Imre Bartos, New York, NY (US); Zsuzsanna Marka, New York, NY (US)

(21) Appl. No.: 16/066,875

(22) PCT Filed: Jan. 4, 2017
(86) PCT No.: PCT/US17/12128

§ 371 Date: Jun. 28, 2018

Related U.S. Application Data
(60) Provisional application No. 62/274,668, filed on Jan. 4, 2016.

(51) Int. Cl. A01M 1/02

(52) U.S. Cl. CPC A01M 1/026; A01M 1/04

(57) ABSTRACT

Techniques for identifying and tracking pests such as disease vectors include a strobe light source; a digital camera; at least one processor; and at least one memory including one or more sequences of instructions. The at least one memory and the one or more sequences of instructions are configured to, with the at least one processor, cause an apparatus to identify a pest type in a monitored region based on an image captured by the digital camera when the monitored region is illuminated by the strobe light source. The apparatus is also caused to operate a device based on the pest identified.

### CROSS-REFERENCE TO RELATED APPLICATIONS

This application claims benefit of Provisional Application No. 62/274,668, filed Jan. 4, 2016, under 35 U.S.C. § 119(e), the entire contents of which are hereby incorporated by reference as if fully set forth herein.

### BACKGROUND

Insects serve as pests and disease vectors. For example, the Anopheles gambiae and Aedes aegypti mosquito not only annoys humans and livestock by biting but also spreads malaria and Dengue fever. Similarly, tsetse flies are biological vectors of trypanosomes, which cause human sleeping sickness and animal trypanosomiasis. Triatominae (kissing bugs) spread Chagas disease.

Locating, measuring, identifying and interacting with such swarms in real time as they form has been extremely difficult in the field. Reliable tracking of individual pests unobtrusively as they traverse the home, village or the wild has not been demonstrated. Trap-less counting and characterization of pest populations around humans has not been achieved.

Mosquito control is still an unsolved problem in many developing countries. Malaria is epidemic in many places, including sub-Saharan Africa where the majority of the Earth's malaria fatalities occur. Generic control measures rely on toxic chemical and biological agents, while repellents in conjunction with mosquito nets provide additional defense. While these are efficient, they also pose direct danger and serious discomfort to users, albeit small when compared to the grave dangers of malaria. Traditional measures seem to be approaching their peak efficiency in practice, while the malaria epidemic is still ongoing.

As stated above, various approaches employ toxic materials. For example, Tillotson et al. (US Patent application Publication 2010/0286803) describes a system for dispensing fluid (such as insect repellant) in response to a sensed property such as an ambient sound (e.g., known signatures of insect wing beat frequencies and their harmonics). These are proximity sensors that determine that an insect is close enough to warrant fluid dispensing when the amplitude of the wing beat frequency exceeds some threshold value over the background noise.

### SUMMARY

In the work presented here it is determined that an individual or swarm of pests, such as mosquitos, can be identified, then used to control some environmentally friendly remedial action, such as optical barriers. As used herein remedial action includes any action that affects the future effects of the pest or type of pest, including directing or blocking movement of the pest, repelling the pest, marking the pest (e.g., with a scent or fluorescent dye), trapping the pest, counting the pest, affecting a pest function such as vision or flight or reproduction or immunity, infecting the pest with a disease or condition, and killing the pest. A remedial device is a device that effects some remedial action. In some embodiments the remedial action involves one or more traps or unmanned aerial vehicles (UAVs). In some embodiments, one or more uninvited UAVs constitute the pests.

In a first set of embodiments, at least one active optical sensor is used to identify an individual or swarm of pests in a monitored region. The active optical sensor includes a strobe light source and a digital camera. In some of these embodiments, the identified individual or swarm is tracked. In some embodiments the identified individual or swarm is used to activate or target some remedial action, such as activating a light barrier or directing a UAV with pest data collection, pest capture or pest killing apparatus attached to intercept the individual or swarm. In some embodiments, a passive acoustic sensor is used to determine whether to activate the strobe light and digital camera. In some embodiments, an active acoustic sensor is used to determine whether some remedial action is blocked and, in some embodiments, whether some adjusted remedial action should be taken. In some embodiments, when the pest is identified as a bloodfed mosquito and the device is a trap, the trap is operated to test the blood collected by the mosquito. In some embodiments, the system includes components to collect CO₂ and volatile compounds characteristic of human odor from inside a dwelling and release those in the monitored region.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1 is a block diagram that illustrates an example acoustic system in operation to track (including determining past locations, current location or forecast of future locations, or some combination, of) a swarm of insects, according to an embodiment;

FIG. 2 is a block diagram that illustrates an example active optical system in operation to identify a detected or tracked pest to augment a remedial action device, according to an embodiment;

FIG. 3A is an image that illustrates an example image collected by a digital camera of an embodiment of the system of FIG. 2 that shows distinguishing features to identity a pest, according to an embodiment;

FIG. 3B and FIG. 3D are images that depict an example mosquito that has not yet fed on a host, as captured by a digital camera strobe according to an embodiment;

FIG. 3C and FIG. 3E are images that depict an example mosquito that has fed on a host, as captured by a digital camera strobe according to an embodiment;

FIG. 4A and FIG. 4B are images that illustrate example video collected by a digital camera for identifying and tracking a pest, according to various embodiments;

FIG. 4C is an image that illustrates an example composite image indicating tracks and types of multiple pests in a monitored region, according to an embodiments;

FIG. 5 is a block diagram that illustrates an example compact system for identifying and tracking a pest in a monitored region, according to an embodiment;

FIG. 6A through FIG. 6C are block diagrams that illustrate various remedial systems for generating an optical barrier to pests, according to various embodiments;

FIG. 7 is a block diagram that illustrates an example system that integrates an identification system with an optical barrier to pests, according to an embodiment;

FIG. 8A is a block diagram that illustrates an example active acoustic detection of an object that blocks some remedial action, according to an embodiment;

FIG. 8B is a block diagram that illustrates an example system that integrates an blocking detection system with an optical barrier to pests, according to an embodiment;

FIG. 9 is a block diagram that illustrates operation of an example identification system based on a UAV with an on board strobe and camera, according to another embodiment;

FIG. 10 is a block diagram that illustrates a computer system upon which an embodiment may be implemented;

FIG. 11 illustrates a chip set upon which an embodiment may be implemented; and

FIG. 12 is a diagram of example components of a mobile terminal (e.g., cell phone handset) for acoustic measurements, communications or processing, or some combination, upon which an embodiment may be implemented.

### DETAILED DESCRIPTION

A method and apparatus are described for automated identification of pests and disease vectors. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Notwithstanding that the numerical ranges and parameters setting forth the broad scope are approximations, the numerical values set forth in specific non-limiting examples are reported as precisely as possible. Any numerical value, however, inherently contains uncertainty necessarily resulting from the standard deviation found in their respective testing measurements at the time of this writing. Furthermore, unless otherwise clear from the context, a numerical value presented herein has an implied precision given by the least significant digit. Thus a value 1.1 implies a value from 1.05 to 1.15. The term “about” is used to indicate a broader range centered on the given value, and unless otherwise clear from the context implies a broader rang around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Some embodiments of the invention are described below in the context of identifying and optionally tracking mosquito individuals and swarms for counting or for initiating remedial activity. However, the invention is not limited to this context. In other embodiments other insect and non-insect pests (including rodents and other small animals and UAVs) are identified and optionally tracked by their optical signatures. As used herein, swarm refers to any ensemble of multiple individuals whether or not they move in a coordinated fashion that is often called swarming behavior.

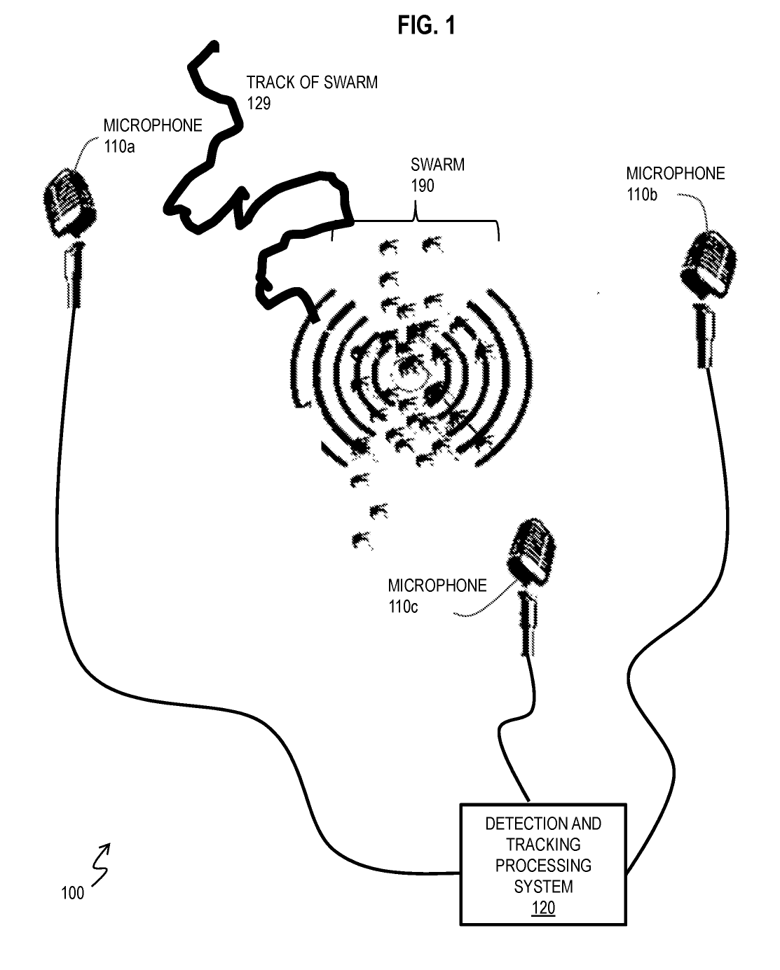

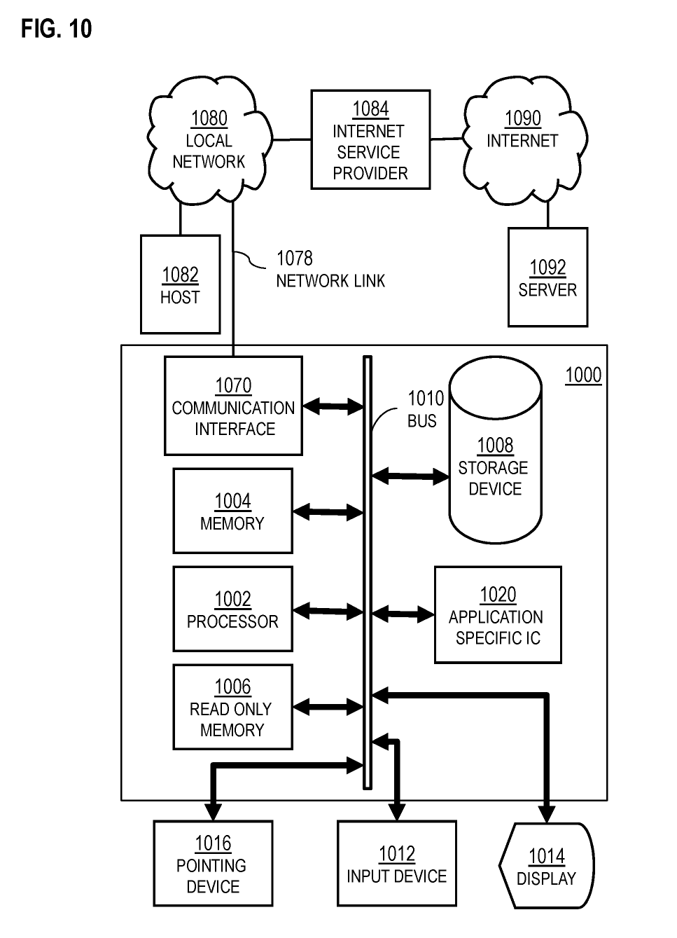

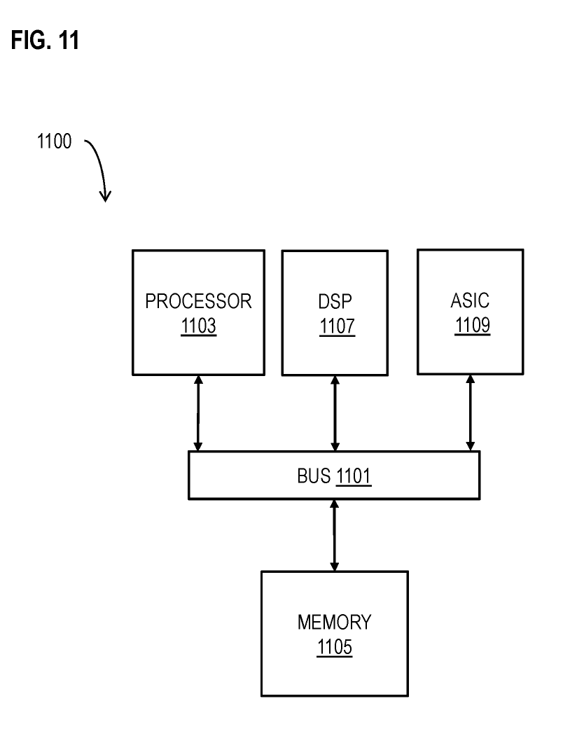

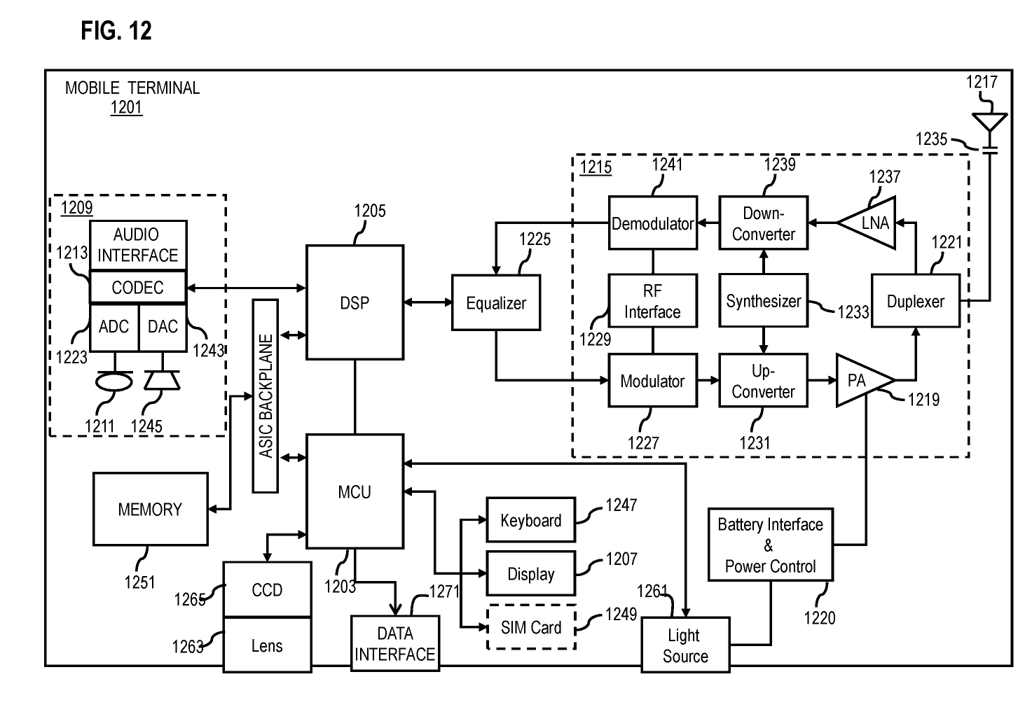

FIG. 1 is a block diagram that illustrates example system 100 in operation to locate and track a swarm 190 of insects by passive acoustics, according to an embodiment. Although a swarm 190 is depicted, the swarm 190 is not part of system 100. By detecting the acoustic signature of the pests in the swarm 190 at a plurality of microphones (e.g., microphones 110a, 110b, 110c, collectively referenced as microphones 110) the location of the swarm can be inferred automatically by the detection and tracking processing system 120, as described in a previously filed patent application. Methods for location include triangulation, multilateration and numerical approximations. Although individual pest have signatures with known characteristics, e.g., associated with wingbeats or calls, the actual waveform is not continuous but is made up of temporal changes, as the pest maneuvers or responds to environmental changes. The timing of such distinctive events will arrive at distributed microphones at different times. This information is used, in various methods, to determine direction for the source of the distinctive signal actually measured at the distributed microphones. The detection and processing system 120 comprises one or more processors, such as depicted in a computer system, chip set and mobile terminal in FIG. 10, FIG. 11 and FIG. 12, respectively, described in more detail below with reference to those figures. In some embodiments, the type of pest (e.g., species of mosquito and gender) is also inferred from the passive acoustic signature.

For example, in some embodiment, relative signal strengths and relative arrival time of events are measured through cross-correlation, auto-correlation, and root mean square (RMS) maximum computation. In some embodiments, the three dimensional (3D) space surrounding the microphone network is covered by a rough virtual grid and each 3D grid vertex is tested as a possible emitter. The grid point with the closest match to the observed delays and amplitude ratios by the microphones is selected. The 3D space around the selected 3D grid point is covered by a finer 3D grid and the most likely grid point is identified. Finer and finer grids are created recursively, converging on the most likely point of acoustic emission. The iterations are finished when sufficient accuracy is reached or when the grid is so fine that grid-points do not produce differences that are recognizable. This algorithm is very fast and robust against dynamical changes in the microphone network geometry, as long as it the microphone geometry is known, or can be reconstructed, for the moment of the sound recording. This is advantageous for rotating or flying microphone arrays, especially if the swarm or individual is relatively stationary compared to the moving array of microphones.

In some embodiments, tracking an individual, or a known number (or estimated number) of individuals in a swarm with a continuous signal without distinctive events, the source strength of the unique acoustic signature is known, and the distance from a microphone to the individual or swarm can be estimated from the amplitude alone of the signal received at each microphone. Estimated number of individuals in a swarm can be gleaned from independent measurements (e.g., photographs), historical records and statistical analysis. In some embodiments, the number of individuals can be estimated by the maximum amplitude observed over an extended time period, or frequency changes with wind speed, or fine frequency resolution.

In some embodiments, signal characteristics allow one to distinguish between cases of one, few and many, individuals in a swarm. By finding a location where the distance to each microphone agrees most closely with the estimated distance, the location of the individual or swarm center can be determined, along with a degree of uncertainty in the location, by the system 120 automatically. For example, frequency bandwidth of acoustic signals from an individual is relatively narrow over a short time and can change substantially over time as the individual maneuvers. The broader the frequency peak in the short term, the greater the number of individuals that are contributing. Gradually, at large numbers of individuals, the signals include broad peaks that remain relatively homogeneous over time.

In some embodiments, each microphone 110 is a directional microphone and is configured to be pointed in different directions. By pointing each microphone in a direction of maximum amplitude of the known acoustic signature of the pest, the location where the directions of the microphones most closely converge is taken as the estimated location of the individual or swarm with a degree of uncertainly estimated based on the distance between points of convergence. An advantage of this embodiment is that the signal can be continuous without discreet events and the number of individuals in the swarm need not be known or estimated a priori. Indeed, after the location is determined, the distance to each microphone can also be determined and, as a consequence, the number of individuals in the swarm can be estimated a posteriori by the system 120 automatically. A further advantage is that the noise in the main lobe of the directional microphone is less than the noise detected in an omnidirectional microphone. Still further, the directional microphones can be disposed to point in directions where the noise is expected to be less, e.g., downward where there are few sources, rather than horizontally where there are many potential noise sources. Microphones are available with different directional responses, including omnidirectional, bi-directional, sub-cardioid, cardioid, hyper-cardioid, super-cardioid and shotgun.

Multiple geographically separated directional or arrays of microphones with overlapping sensitive range can cover an area and each directional microphone or array can supply direction(s) to the pests. Since the locations of the stationary or airborne microphones are known, the directions provide a location for the pests. By combining the direction information of an individual or swarm or pests from multiple arrays or directional microphones, a region of intersection can be determined. A position within the region, such as the centroid, is taken as the location of the individual or the center of the swarm, and the size of the region of intersection is taken as the uncertainty of the location or the size of the swarm or some combination.

The time series of such positons constitutes a track 129 of the swarm or individual. Based on the location of the swarm and its approach or retreat from an asset, such as a person, a dwelling or a crop, it is determined whether to deploy some remedial action.

In various embodiments, the individual or swarm is tracked but identification is uncertain or different pest types are mixed. In such cases it is useful to identify or confirm identification of the pest and optionally the number and behavior of the pest, e.g., before initiating remedial action.

For example, methods that help understand and control the spread of mosquito vectors often rely on field data collected by capturing and categorizing mosquitoes in their natural environment. Retrieving data from insect traps is done manually, making the procedure costly, error prone, and travel and labor-intensive. It would be advantageous to automatically identify, characterize, and measure insects as soon as they enter the trap's range. Such a capability, called smart traps herein, would revolutionize entomological data collection and resulting action, enable research and monitor the success of field trials, such as area-wide sterile males release efforts, in ways that were not possible previously. Smart traps for collecting extensive information while monitoring mosquitoes provide the necessary stringent statistical input for the evaluation of field trials for upcoming new approaches in vector control with suppression of disease transmission in mind. Smart traps would also be able to measure mosquito fitness, therefore providing a quantitative and repeatable baseline data for lab raised sterile male fitness; thus, ensuring effective sterile insect technique releases. In some embodiments, smart traps do not require human visits and can also be placed at those key locations where frequent operator access is difficult—and protect people where they are most vulnerable, their homes and gardens.

The automation of the classifying, counting and eradication procedure can greatly reduce insect control costs and speed up eradication, improve an outdoor experience, and also accelerate research. Beyond making data collection cheaper and faster, automatic identification and tracking also enables the real time monitoring of the arrival time and coordinates of mosquitoes, which is impossible with a passive trap. Such temporal information can be critical in understanding the flight pattern and daily cycle of mosquitoes, that enables low cost targeted extermination.

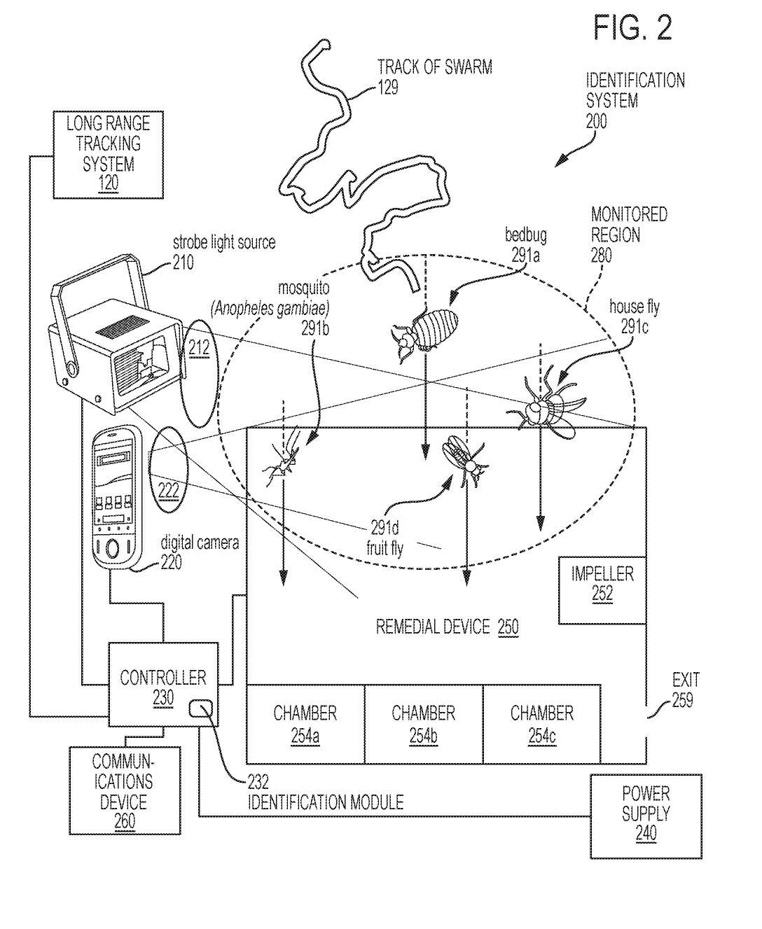

FIG. 2 is a block diagram that illustrates example active optical system 200 in operation to identify a detected or tracked pest to augment a remedial device 250, according to an embodiment. Although a track 129 of a swarm and example pests, including a bedbug 291a, Anopheles gambiae mosquito 291b, house fly 291c and fruit fly 291d (collectively referenced as pests 291), are depicted for purposes of illustration, neither track 129 nor pests 291 are part of system 200.

System 200 includes a strobe light source 210, a digital camera 220, a controller 230 that controls operation of both, and a power supply 240 that provides power for the other components. In various embodiments, the controller 230 is implemented on a computer system as depicted in FIG. 10 or chip set as depicted in FIG. 11 or a mobile terminal as depicted in FIG. 12 and includes a processor as depicted in each of those embodiments.

The strobe light source 210 is configured to illuminate a monitored region such as an entry point to an asset of some kind (e.g., a building, a room in a building, a vehicle, or trap), in one or two or three dimensions. The advantage of a strobe light source 210 is that it can be controlled to operate for such a short illumination time as to freeze the wing or rotor motion of most pests, including mosquitos and UAVs, and yet bright enough to allow for a very distinct image to be captured by even a low cost digital camera 220. Furthermore a strobe light source can be configured to light at one or more wavelengths or wavelength bands that further distinguishes a pest from background, such as at one or more wavelengths or bands that induces fluorescent responses from marked pests or at wavelengths or bands that are at reduced intensity levels in the ambient lighting. The resulting image can be used for more successful feature discrimination within the image for use in identifying the pest. Furthermore, stroboscopic illumination allows slow framerate cameras to capture multiple still images of the pest in a single frame, greatly reducing cost and enabling streamlined track, velocity and other measurements. In other embodiments, bright continuous light sources are used that are much brighter than ambient artificial or sunlight light sources. In some of these embodiments, the light source spectral properties are also distinctive from other artificial lighting sources (e.g., street lamps, household lamps) or sunlight. To freeze motion, for some embodiments, such lights are preferably used with fast frame rate digital video cameras or fast shutter digital or analog cameras.

A typical commercial strobe light has a flash energy in the region of 10 to 150 joules, and discharge times as short as 200 microseconds to a few milliseconds, often resulting in a flash power of several kilowatts. Larger strobe lights can be used in “continuous” mode, producing extremely intense illumination. The light source is commonly a xenon flash lamp, or flashtube, which has a complex spectrum and a color temperature of approximately 5,600 kelvins. To obtain colored light, colored gels may be used. The short time and intense power is often provided by a capacitor or bank thereof. Currently, low power, low cost light emitting diode (LED) strobe lights are commercially available utilizing banks of one or more LED elements. Single or multispectral low power or high power LED illumination are used in various embodiments to identify position, velocity, size, or species, among other characteristics, alone or in some combination.

In some embodiments, an optical coupler 212 is included to direct light from the strobe light source onto the monitored region. An optical coupler includes one or more objects or devices used transmit or direct light, including one or more of a vacuum, air, glass, optical fiber, lens, filter, mirror, crystal, diffraction grating, prism, polarizers, acousto-optic modulator (AOM), circulator, beam splitter, among others.

The digital camera is any device capable of detecting light from the strobe light source reflected from one or more objects, including pests, in the monitored region. Example digital cameras include any item with a charged coupled device (CCD) array or a complementary metal-oxide-semiconductor (CMOS) array, including many smart mobile phones, usually with a lens with a variable diaphragm to focus light onto an image pickup device such as the CCD array or CMOS array. A CCD sensor has one amplifier for all the pixels, while each pixel in a CMOS active-pixel sensor has its own amplifier. Compared to CCDs, CMOS sensors use less power. Cameras with a small sensor use a back-side-illuminated CMOS (BSI-CMOS) sensor. Overall final image quality is more dependent on the image processing capability of the camera, than on sensor type. In some embodiments, an optical coupler 222 is included to direct light from the monitored region 280 into the digital camera. In some embodiments, the optical coupler 222 includes one or more optical filters that each only allows one of the strobe colors to pass, which can be exchanged in the optical path from the monitored region 280 to the camera 220. Each filter offers the advantage of ensuring extremely dark and out of focus background while still enabling high contrast and bright images of the pests being detected.

The strobe light source and digital camera are operated by the controller 230. In some embodiments, the strobe light and digital camera are operated by controller 230 on a predefined schedule or in response to an acoustic tracking system that determines track 129. In some of these embodiments, the strobe light source 210 and digital camera 222 are operated when the acoustic tracking device indicates the track 129 is approaching or has entered a monitored region 280 that can be illuminated by the strobe and imaged by the camera. In some embodiments, the strobe light source 210 and digital camera 220 are operated by controller 230 to detect when an object and potential pest is in the monitored region, either in addition to or instead of the acoustic tracking system that produces the track 129. In this surveillance mode, strobe light sources can be flashed for very small times at low power mode to illuminate incoming objects, therefore avoiding additional LEDs for surveillance mode. Only when an object is detected in the monitored region is the full operation of the strobe and digital camera performed for identification purposes.

The power supply 240 can be any power source suitable to an application, including local power grid, batteries, generators, geothermal and solar. For monitoring traps in remote areas, for example, banks of one or more solar power cells serve as a suitable power supply 240.

In some embodiments the system includes a communications device 260 for communicating with a remote platform, such as a remote server or bank of servers (not shown) running an algorithm to determine when to operate the strobe light source and digital camera, or a remote human operator making those determinations manually, and sending those determinations as data through the communications device 260 to the controller 230.

In some embodiments, the system includes the remedial device 250, such as a light barrier, described in more detail below, or a trap, or a marking device, or a UAV. In some embodiments, the device includes multiple chambers for collecting pests of different types, such as chambers 254a, 254b, 254c (collectively referenced hereinafter as chambers 254) such as for counting and population studies. In some of these embodiments, the remedial device includes an impeller 252 configured to move pests into or through the device, e.g., into one or more of the chambers 254 or to an exit 259. For examples, an object that enters a trap but is not a desired target of the trap can be impelled to exit the trap. Or target pests that have been marked inside the device 250 are then release through exit 259 for some purposes as described below.

In various embodiments, the fate of an object or pest entering the device 250 is based on identifying the individual or swarm as a member of a certain pest type or group of types. The system 200 is configured to include an identification module 232. The identification module 232 is depicted in the controller 230, but in other embodiments all or part of the module 232 resides in an external processor, such as a remote server (e.g., as depicted in FIG. 10), and the controller 230 communicates with the remote server via communications device 260.

The identification module 232 identifies a pest based on one or more images collected by digital camera 220 and operates a device, such as a display device or graphical user interface, or the communications device 260 or the remedial device 250, or some combination, based on the identified pest. In some embodiments, the controller 230 operates the strobe light source 210 or the digital camera 220 based on the identified pest determined by the identification module 232.

In some embodiments, a smart cellular phone with camera and flash can be operated to provide the strobe light source 210, the digital camera 220, the controller 230, the power supply 240, the communications device 260 and all or part of the identification module 232. By wired or wireless communication (e.g., BLUETOOTH), the cellular phone can then issue one or more commands to the remedial device 250.

An embodiment of system 200 in which the remedial device 250 is an insect trap with one or more controllable impellers 252 or transparent compartments 254 is called a smart trap, herein. An embodiment of system 200 that excludes the remedial device 250 is called a smart aperture herein because it can identify the pests in a monitored region 280 that serves as the aperture to an existing remedial device, such as the BG-SENTINAL™ mosquito traps available from BIOGENTS™ AG of Regensburg, Germany, or the DYNATRAP™ available from DYNAMIC SOLUTIONS WORLDWIDE™ LLC of Milwaukee, Wis. For example, smart traps that operate their suction (impeller) in response to sensed approaches and that actively try to catch insects they sense approaching their intake can be more effective than passive or continuously operating devices. In some embodiments, smart apertures or smart traps alert operators when a special catch arrives to ensure good preservation.

The system 200 provides multispectral detection, identification, and tracking of flying objects and animals, which enables a wide range of possibilities from active operation of light barriers to selective extermination of flying pests in gardens and dwellings. For example, as described in more detail below, light barriers detect and optionally identify incoming pests as mosquitoes, including their position, velocity, gender, and other attributes that are useful for light barrier operation. An active light barrier switches on in response to identification of the incoming mosquito. Only the small portion of the light barrier is energized that is covering the mosquito's projected trajectory at the optimal time. In some embodiments, only female mosquitoes, which are the biting gender, are repelled to save energy and cost. In some embodiments, all or parts of the system are deployed on flying drones (UAVs) that optically identify and kill pests, such as disease vectors, inside dwellings, and in and around other assets, such as residents' gardens, villages, communities, livestock farms, recreational areas such as golf courses, among others.

In some embodiments, networked intelligent insect traps (smart traps) using system 200 make decisions themselves or wirelessly transmit rich data about the ‘catch’ real-time, and also differentiate between various species, size, and gender. Such smart traps can automatically determine the size, age, species, color, bloodfeeding status, gender, fitness, count, catch time, catch rate, presence of a fluorescent marker, and possible presence of genetic modification through real-time multispectral LED imaging and potentially through synchronized acoustic sensing.

For remediating mosquitoes, system 200 can help understand and control the spread of mosquito vectors based on field data collected by capturing and categorizing mosquitoes in their natural environment. This new approach supplants conventional methods of retrieving data from insect traps manually, which makes the conventional procedure costly, error prone, and travel and labor-intensive. In contrast, smart traps identify, characterize, and measure mosquitoes as soon as they enter the trap's range, which can revolutionize entomological data collection and resulting action, and enable research and monitor the success of field trials, such as area-wide sterile males release efforts, in ways that were not possible previously. The new methods for collecting extensive information while monitoring mosquitoes provide the necessary stringent statistical input for the evaluation of field trials for upcoming new approaches in vector control with suppression of disease transmission in mind. Smart traps also are able to measure mosquito fitness, therefore providing a quantitative and repeatable baseline data for lab raised sterile male fitness; thus, ensuring effective sterile insect technique releases. Smart traps that do not require human visits can also be placed at those key locations where frequent operator access is difficult—and protect people where they are most vulnerable, their homes and gardens.

The smart trap technology can also be used to retrofit conventional traps with strobe, camera, and other optional components of system 200, including passive acoustic tracking and characterization. Smart apertures provide the imaging (and possibly acoustics) as well as communication. Smart traps can also be implemented as a ‘flow through trap’ (these can also have ‘kill on the fly’ aspect) that do not collect but precisely characterize insects flowing through it. Autonomous operation significantly reduces survey and extermination expenditures while also enabling the collection of data that was not available previously in an ecologically friendly manner More resources become available for fun, research, and eradication to concentrate on interventions and impact. Further, given the possibility of remote data collection, the cost of an experiment is practically the cost of the devices and their placement, and the cost and burden of regular visits to the traps by expert scientists or technicians can be partially or completely avoided. This can allow for unprecedented larger scale and longer term observation campaigns. For example, a smart trap retrofit cost savings would be substantial. Assuming that 416 BG-Sentinel traps required about 4.5 field test engineers (FTE) to service and identify trap catches for the Eliminate Dengue project, and that an FTE costs $40,000 per year, and that 1 FTE can service about 100 traps, then at a cost of less than $100 per trap, a two smart aperture retrofit is recovered in less than 3 months of FTE salary saved. Furthermore, the collected samples in regular traps may dry out, are sensitive, and can be contaminated by other insects attracted. Mass production can reach significantly lower cost per smart apertures retrofit. Further, beyond the undoubtedly important research and surveillance purposes, the instant identification and autonomous operation makes the technology likely to gain market in the insect/pest control business, as well as in widespread home use.

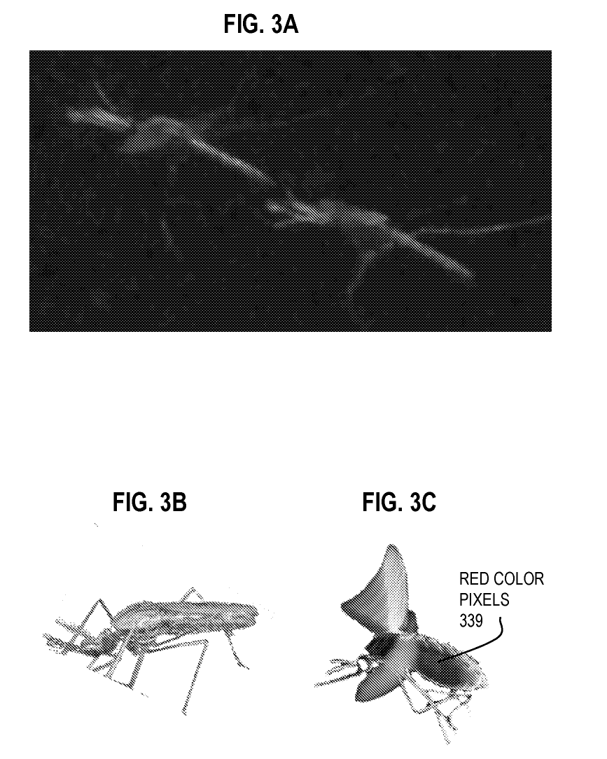

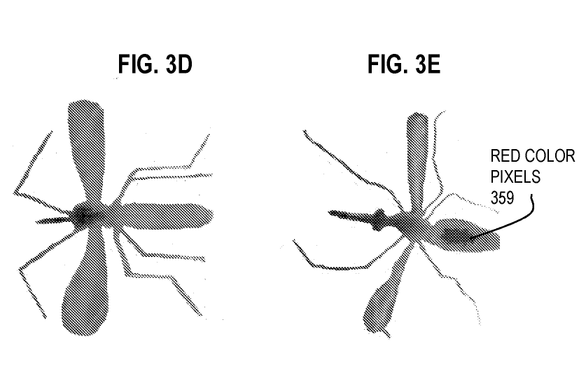

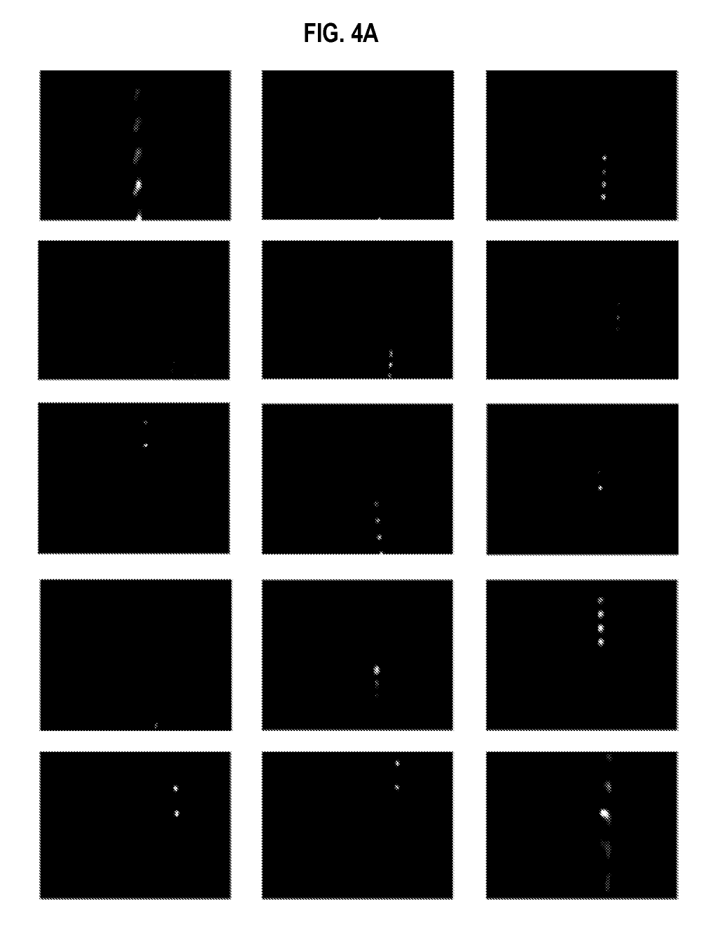

FIG. 3A is an image that illustrates an example image collected by a digital camera of an embodiment of the system of FIG. 2 that shows distinguishing features to identity a pest, according to an embodiment. This single frame image is from two stroboscopic illuminations of a single mosquito in the trap. In some embodiments, the frame will contain the image of the mosquito in different colors and thus allow spectroscopic analysis. This image is based on a basic cell phone quality camera. A laboratory test allowed the verification of key points of the low-cost/low-power apparatus. 1.) A small fan (possibly bladeless!) can be used as impeller 252 to efficiently guide mosquitoes to the imaging apparatus at the required speed for stroboscopic multispectral imaging. 2.) Commercial LED technology is sufficient and available in a wide range of colors and the LEDs can be controlled at the required high frequency for good stroboscopic quality image recording using standard cell phone quality camera. 3.) The collected data can be transferred to a central server using the cell phone service. 4.) Parameters determining size, velocity, gender, count, catch time, and bloodfed status are fairly straightforward to determine from the high quality image collected. For example, bloodfed mosquitoes exhibit smaller aspect ratios, slower travel speeds, and more intensity at red wavelengths compared to unfed mosquitoes, as well as other spectral features characteristic of bloodfed mosquitoes, any of which alone, or in combination, can be used as a parameter of bloodfed status. FIG. 3B and FIG. 3D are images that depict an example mosquito that has not yet fed on a host, as captured by a digital camera strobe according to an embodiment. FIG. 3C and FIG. 3E are images that depict an example mosquito that has fed on a host, as captured by a digital camera strobe according to an embodiment. The bloodfed mosquito of FIG. 3C and FIG. 3E has a smaller ratio of length to height because of an extended abdomen and also has a higher intensity abdomen when illuminated by a red light source or filtered through an optical filter that passes only red wavelengths or some combination. Pixels 339 and 359 are detected as red color in spectral measurements in FIG. 3C and FIG. 3E, respectively. The red spectral characteristic can also be used to distinguish a bloodfed mosquito from a sugar-solution-fed mosquito that does not display the red color pixels.

The size can be measured from the image knowing the distance from the camera, e.g. through stereo imaging. The image of FIG. 3 is clear and has the mosquito abdomen length at 100 pixels. An image that is a factor of 2 smaller still allows aspect ratio measurement, and that is a factor of 10 to 20 smaller (e.g., abdomen length of about 5 pixels) still allows color measurements. Species and gender can be identified from multispectral images using distinct body shape, size and coloring. Velocity can be identified from the distance traveled between consecutive flashes of the strobe (and or frames of a fast camera that does not use strobe). Time is determined from the timestamp of the image. Count is determined from the series of frames taken of the monitoring region, which are not likely to be tracks of the same individual (e.g., involving out of bounds accelerations).

Independent spectroscopic investigations suggest that adding additional colors between ultraviolet (UV) and infrared (IR) to the system further help with species, age, and blood meal status identification. The color resolution of a commercial digital camera, as used to produce FIG. 3A through FIG, 3C, is apparently more than enough, but spectroscopy can also work. Spectroscopy can be based on monochromatic illumination, fiber based spectroscopes, grating based spectroscopes, prism based spectroscopes, and others. Any spectroscope that has better than 50-100 nanometer (nm, 1 nm=10⁻⁹ meters) wavelength resolution will do to detect the difference in red color that distinguishes bloodfed status of a photographed mosquito.

The components for the smart trap or smart aperture, once the programming for the identification module 232 is set, can be obtained using commercial off the shelf devices. Thus, it is clear that quality smart traps or smart apertures for retrofitting existing traps can be built at reasonably low cost. For example, the cameras used for the experiments depicted herein included: Casio EXILIM EX-F1 from CASIO COMPUTER CO., LTD.™ of Shibuya-ku, Tokyo 151-8543, Japan; ArduCam for RasPi Apple iPhone5 camera from APPLE COMPUTER, INC.™ of Cupertino, Calif. 95014. The spectrometer used was LR-1 from ASEQ INSTRUMENTS™ of Vancouver, Canada. The LEDs for monochromatic illuminations used were LedEngin LZ1 series colors from LED ENGIN™ of San Jose, Calif.

The identification of the pest or its status in the monitored region is used to determine how the smart trap is operated. For example, in some embodiments, a bloodfed mosquito is used as a “flying vial” for human/animal genetic ID and blood-borne disease survey. The mosquito will take about 1-10 microliters of blood that is sufficient amount for blood testing and DNA sequencing. The bloodfed mosquito is preferentially captured in one or more of the chambers 254 where blood testing is performed. The blood tests can indicate the species of the blood donor because animal and human blood are quite different. The pathogens present in the bloodstream of the human victim are present in the blood collected by the mosquito and can be diagnosed. For example, the mosquito can also be tested for malaria transmission. The DNA profile extracted from the blood, e.g., using fluorescent DNA segment micro-arrays, can be used to identify the human victim and allow for the cure of sick people, quarantining the infected people, identification of the most often infected, stopping of epidemic, and other purposes. (e.g., ebola patients might suffer at a hidden location but mosquitoes might bring news about their existence). Microfluidics devices can be used as they do HIV test from 1 microliter of blood. Thus, if the trap detects a blood-fed mosquito, it can selectively store it in a preservation container as one or more of the chambers 254 (e.g., a chamber subjected to chemical or physical (cold or vacuum) preservation) or even do in-situ testing through microfluidics or other techniques. Thus the trap includes a chamber with a blood testing device or a chamber with physical or chemical preservation that allows off-site testing or some combination.

Smart Traps with access to electricity can collect carbon dioxide (CO₂) and volatile compounds characteristic of human odor out of the air inside a dwelling. The later controlled release of this collected gas can serve as a powerful attractant to bring mosquitos to smart traps and UAVs, thus greatly enhancing their effective operation. CO₂ and human scent secretions are known to be the best attractants and are usually available in the air of spaces occupied by humans. Synthetic attractants used today are performing poorly relatively to these. Such synthetic attractants are used because CO₂ cylinders are rarely available in the field. The locally made CO₂ enriched with human odor compounds is a significant enhancement over existing systems. Thus in some embodiments, the smart trap includes a system for collecting carbon dioxide or human produced volatile compounds out of the air into a reservoir; a mechanism to release carbon dioxide and human produced volatile compounds into the monitored region from the reservoir.

A possible method to collect CO₂ and human odor compounds from air is by freezing them out. The inside air from the dwelling or outside air is collected by a pipe that in some embodiments is pre-cooled by the cold return gas from the freezer system. In some embodiments the mixture of air, carbon-dioxide, organic volatiles, water vapor and other molecules are cooled to temperatures for example between −5 and −20 Celsius and precipitated in a dryer-freezer that removes the water vapor and organic volatiles that freeze in this temperature range. In some embodiments, the dryer-freezer can be preceded by a dryer-compressor air tank, which is especially advantageous in hot and humid climates to aid in the removal of water vapor and cooling. In some embodiments, the gas then continues to an intermediate-freezer that, for example, operates between −40 and −35 Celsius to precipitate more organic volatiles and further cool the gas. A further stage in some embodiments comprises a low-temperature-freezer, for example operating between −85 and −80 Celsius, which freezes out the carbon dioxide from the gas stream. The remaining cold gas is then pumped out in some embodiments next to the incoming gas to provide pre-cooling and efficient energy use. The resulting cold gas, mostly nitrogen and oxygen, can be vented or in some embodiments used as an air conditioning supplement. The dryer-freezer can be, for example: MR040E-U1 from ENGEL™ of, Jupiter, Fla. or Norcold NRF-30 portable freezer from THETFORD™ of Sidney, Ohio or Model ULT-25NE from STIRLING ULTRACOLD SHUTTLE™ of Athens, Ohio. The Intermediate-freezer and Low-Temperature-freezer can also be, for example, the Model ULT-25NE. The Dryer-compressor can be for example: SL50-8 Dental Air Compressor from SMTMAX™ of Chino, Calif.

In some embodiments, CO₂ and organic volatiles can be collected via suitable adsorption agents such as Zeolites (for example, from Zeo-Tech GmbH of Unterschleissheim, Germany, and reintroduced via heating up the adsorption agent.

The collected water, organic volatiles and carbon-dioxide can be stored, placed into the traps, e.g., in one or more compartments, dispensed into the traps or monitored region automatically directly from the warmed up freezers or collectors or other suitable manners. The volatiles and water can be dispersed via heating, ultrasonic dispersers or other suitable methods while the carbon-dioxide can be returned to gas phase through heating and its slow release can be controlled through flow control valves. For example, an ultrasonic disperser can be a Travel Ultrasonic Humidifier from PURE ENRICHMENT™ of Santa Ana, Calif. Flow control valves can be, for example: Omega Programmable Mass Flow Meter and Totalizer FMA-4100/4300 Series, from OMEGA ENGINEERING, INC. ™ of Norwalk, Conn. or Parker Flow Control Regulators from, FLUID SYSTEM, CONNECTORS DIVISION of Otsego, Mich.

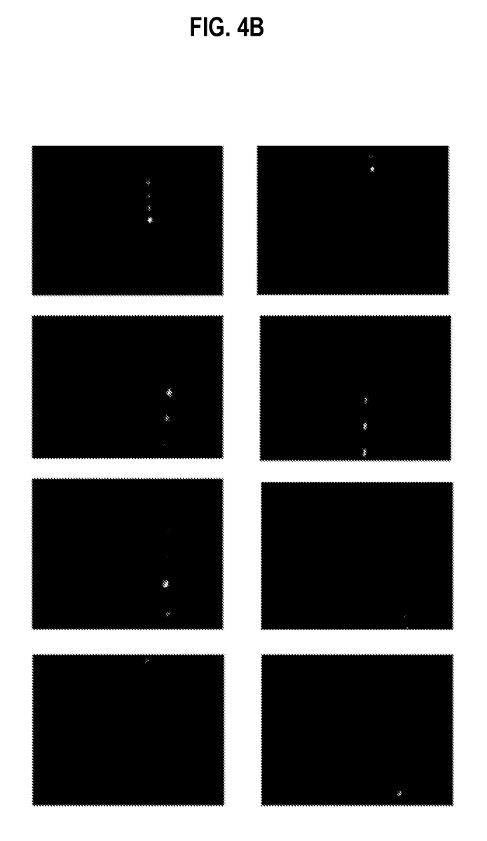

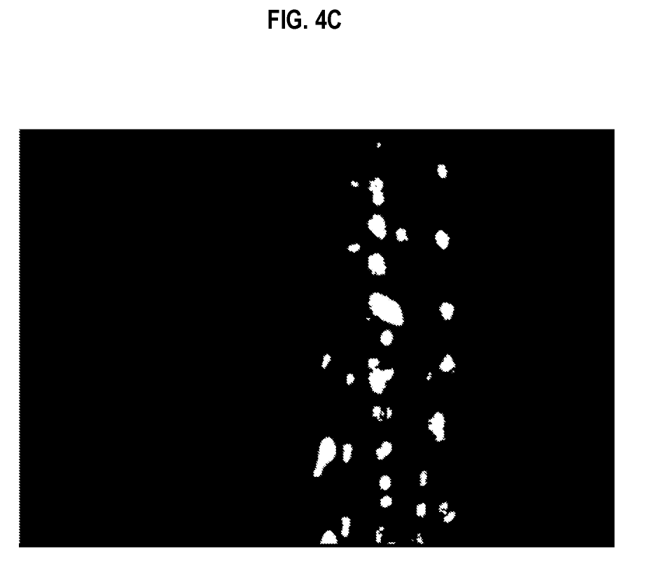

FIG. 4A and FIG. 4B are images that illustrate example images collected by a digital camera for identifying and tracking a pest, according to various embodiments. The experimental setup included the strobe light source 210, a digital camera 220 and an optical filter in the coupler 222 to pass only the strobe light source wavelength. In this experimental embodiment, a GENRAD™ 1531-AB Stroboscope, available from IET Labs, Inc. of Roslyn Heights, N.Y., was used. It is capable of 110 up to 25,000 flashes per minute. Each flash is of very short duration to stop motion for photography. The digital imagery was captured on an iPhone 5 available from Apple Inc., of Cupertino, Calif., which served as the digital camera. This indicates sufficient quality is obtained with widely available equipment. The monitored region extended from 4 to 19 inches from the camera. In these images the strobe illuminated the field of view several times (e.g., about four times) during the shutter open time, or integration time, of the digital camera.

Computer analysis visualized individual insect entering or moving through the field of view. The background was subtracted from the images and the remaining was displayed. Most of the insects had been saturated due to the intense strobe. Since the strobe light's frequency was known, the velocity can be computed from the consecutive strobed images. In this experimental embodiment, the insects were falling with terminal velocity. In various images various different pests (mosquito, bedbug, fruit fly, house fly) were located and tracked. These images make it evident that counting, tracking, and size/velocity measurement are each possible, alone or in some combination. Even without precise visual features, pest species can be inferred from size and velocity.

FIG. 4C is an images that illustrates an example composite image indicating tracks and types of multiple pests in a monitored region, according to an embodiments. The image demonstrates stroboscopic sensing of arthropods of various sizes and species (mosquito, bedbug, fruit fly, house fly) moving through the field of view of the device. The cumulative result of the computer analysis of the insect tracks has clearly been recorded by the apparatus. It clearly demonstrates that high signal to noise ratio detection is possible with very simple setups.

In another experimental embodiment, LED strobes were used. For example, LEDs available from LED ENGIN™ Inc. of San Jose, Calif., were used for multispectral illumination (blue and amber LEDs were flashed off-phase). Thus, consecutive images are collected of the object in blue then amber, and the alternating illuminations were repeated. Much better images were produced with LED strobe lights, such as the amber image depicted in FIG. 3, which was also taken by the iPhone 5. The magnified still image shows the high quality obtained with this newer method, clearly showing features that can be used to automatically identify a male mosquito.

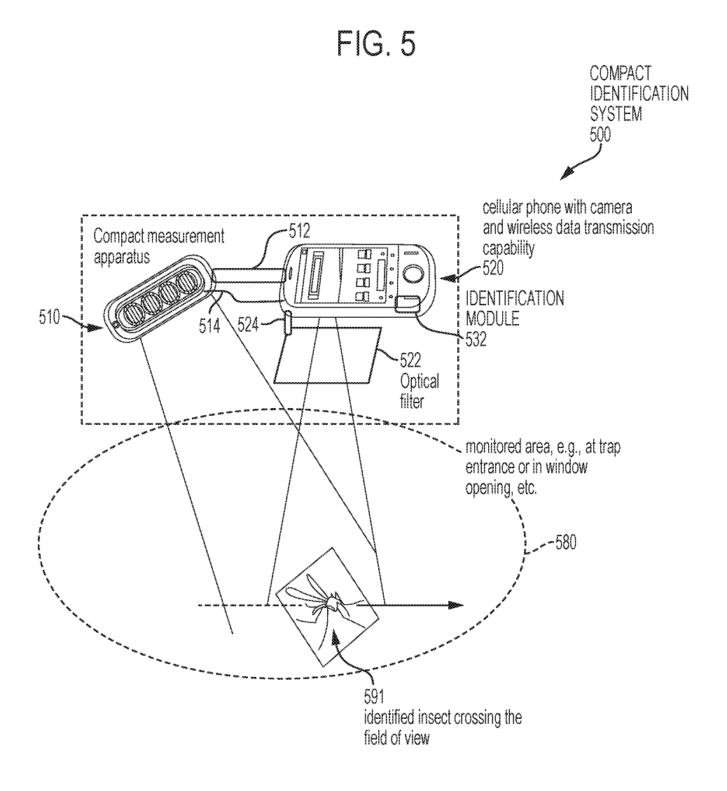

FIG. 5 is a block diagram that illustrates an example compact system for identifying and tracking a pest in a monitored region, according to an embodiment. In this embodiment, a smart cellular phone 520 with camera and wireless data transmission capability is coupled with a low power single or multispectral (e.g., four colors) LED strobe 510. The size of the strobe 510 is about 4 centimeters weighing about 20 grams and the size of the cellular phone 520 is about 10 centimeters weighing about 200 grams. The cellular phone optics are augmented with an optical filter 522 to pass one or more colors of the strobe 510. In the illustrated embodiment, the strobe 510 is mechanically fixed to the cellular phone 520 by a structural member 512, and the filter 522 is fixed to the cellular phone 50 by structural member 524. In some embodiments, the structural member 524 is configured to allow four filters to be interchangeably placed in front of the cellular phone optics, e.g., by rotating a wheel with four colored filters.

The processing components in the cellular phone 520 are configured with an identification module 532 (such specific modules are known as phone “Apps” in current terminology) to perform one or more functions of the controller 230 and identification module 232. In some embodiments, the inherent communications capability of the cellular phone are used as a communication device 260 to communicate with a remote server that performs some or all of the functions of the controller 230 and identification module 232. In the illustrated embodiment, the LED strobe 510 is controlled by commands issued form the cellular phone 520 though a wired or wireless communication channel 514.

This compact product concept for optical surveillance of pests is capable of internet based data transfer to a remote data aggregator/processing computing cluster. In a preferred embodiment, the low power LED based strobe ensures that the flashing rate is high, the flash is single color and that it is not visible for humans or pests. The optical filter only allows the single strobe color to pass. The system can operate on battery/solar power and transmit rich pre-processed data to a remote server for further analysis or make decisions on-board autonomously.

Extra functionality that can enhance effectivity in various embodiments include the following. 1.) Integrated smart traps that only release lure when necessary and only consume full power when insects are present. This can save significant amount of electricity and preserve the catch in a best condition. 2.) The comprehensive spectral coverage (UV-VIS-IR) imaging technology will be able to identify mosquitoes marked with fluorescent methods. Also, if mosquito swarms with a known size are marked, the fraction of marked males in the traps can aid in the statistical deduction of total male population. 3.) Synchronized acoustic tracking: an add-on feature enabling detailed characterization of only the mosquitoes approaching the trap. For example, male mosquitoes are often found in the vicinity of traps using traditional lures for female mosquitoes, but do not enter the trap. Traps that can sense insects circling its entrance can provide critical information about a broader range of populations, especially on the elusive male mosquitoes (e.g., males have a differing acoustic signature).

For example, using system 500, automation of the classifying, counting and eradication procedure (e.g. through cell phones performing the image analysis and transferring data to a central data aggregator service) can greatly reduce insect control costs and speed up eradication, better outdoor experience, and also accelerate research. Beyond making data collection cheaper and faster, automatic identification also enables the real time monitoring of the arrival time and coordinates of mosquitoes, which is impossible with a passive trap. Such temporal information can be critical in understanding the flight pattern and daily cycle of mosquitoes, that enables low cost targeted extermination.

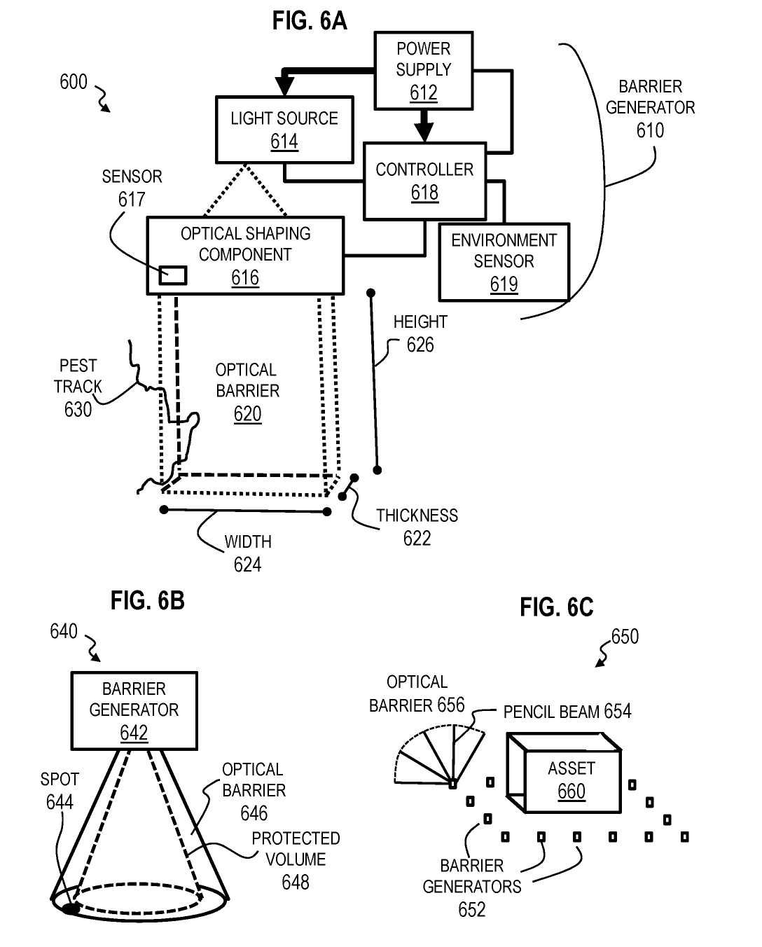

FIG. 6A through FIG. 6C are block diagrams that illustrates various remedial systems for generating an optical barrier to pests, according to various embodiments. Such optical barriers are described in U.S. Pat. No. 886,411, the entire contents of which are hereby incorporated by reference as if fully set forth herein. FIG. 6A is a diagram that illustrates a system 600 for generating a barrier to pests, according to one embodiment. The proposed system does not contribute to the chemical or biological load on humans and the environment. This new method practiced by this apparatus provides defense in two or more dimensions for a community, in contrast to traditional approaches requiring physical contact between chemical agents and mosquitoes. The illustrated embodiment does not require cumbersome physical barriers; and eliminates pitfalls related to human negligence during daily installation of nets and inadequate coverage of chemical treatments. The protected volume can be easily and permanently sized for children, thus no adults can re-use the children's devices for their own purpose. In some embodiments, the barrier provides visual feedback on the state of protection by default; therefore no expertise is necessary to evaluate the operational status of the equipment. In some embodiments, where infrared or other light not visible to humans is used, an additional light is added to the device that provides visual feedback of correct orientation and operation.

System 600 includes a barrier generator 610 that produces an optical barrier 620 at least intermittently. In the illustrated embodiment, the barrier generator 610 includes a power supply 612, a light source 614, optical shaping component 616, controller 618 and environment sensor 619. In some embodiments, one or more components of generator 610 are omitted, or additional components are added. For example, in some embodiments, the environment senor 619 is omitted and the generator is operated by controller 618 independently of environmental conditions. In some embodiments, the generator 610 has a simple single configuration and controller 618 is also omitted. In some embodiments, the light source 614 output is suitable for the barrier and the optical shaping component 616 is omitted.

The power supply 612 is any power supply known in the art that can provide sufficient power to light source 614 that the light intensity in the optical barrier is enough to perturb pests, e.g., about one Watts per square centimeter (cm, 1 cm=10⁻² meters). In an example embodiment, the power supply is an outlet from a municipal power grid with a transformer and rectifier to output a direct current voltage of 2.86 Volts and currents between about one and about 100 Amperes. For example, an Agilent 6671A J08-DC Laboratory Power Supply (0-3V, 0-300A) manufactured by Agilent Technologies, Inc., 5301 Stevens Creek Blvd., Santa Clara, Calif., is used. Any DC power supply providing sufficient voltage, current, and stability to drive the light source is used in other embodiments. In various other embodiments, the power supply is a battery, a solar cell, a hydroelectric generator, a wind driven generator, a geothermal generator, or some other source of local power.

The light source 614 is any source of one or more continuous or pulsed optical wavelengths, such as a laser, lased diode, light emitting diode, lightbulb, flashtube, fluorescent bulbs, incandescent bulbs, sunlight, gas discharge, combustion-based, or electrical arcs. Examples of laser or light emitting diode (LED) sources in the infrared region include but are not limited to 808 nm, 6350 nm, 6550 nm emitters. While the light source of the barrier can be any kind of regular light source, laser light sources are expected to be more suitable due to the increased abruptness and controlled dispersion of laser sources (making it easier to focus laser beams towards the desired portion of space). A scanning beam is often easier to accomplish using laser beams. For example, an experimental embodiment of light source 614 is a laser diode emitting a near infrared (NIR) wavelength of 808 nm in a beam with a total power of two Watts. The optical beam produced by this laser experiences dispersion characterized by an angular spread of about +/−60 degrees in one direction and +/−30 degrees in a perpendicular direction.

The optical shaping component 616 includes one or more optical couplers for affecting the location, size, shape, intensity profile, pulse profile, spectral profile or duration of an optical barrier. An optical coupler is any combination of components known in the art that are used to direct and control an optical beam, such as free space, vacuum, lenses, mirrors, beam splitters, wave plates, optical fibers, shutters, apertures, linear and nonlinear optical elements, Fresnel lens, parabolic concentrators, circulators and any other devices and methods that are used to control light. In some embodiments, the optical shaping component includes one or more controllable devices for changing the frequency, shape, duration or power of an optical beam, such as an acousto-optic modulator (AOM), a Faraday isolator, a Pockels cell, an electro-optical modulator (EOM), a magneto-optic modulator (MOM), an amplifier, a moving mirror/lens, a controlled shape mirror/lens, a shutter, and an iris, among others. For example, an experimental embodiment of the optical shaping component 616 includes an anti-reflection (AR) coated collimating lens (to turn the diverging beam from the laser into a substantively parallel beam) and a shutter to alternately block and pass the parallel beam. Several manufacturers supply such optical components include Thorlabs, of Newton, N.J.; New Focus, of Santa Clara, Calif.; Edmund Optics Inc., of Barrington, N.J.; Anchor Optics of Barrington, N.J.; CVI Melles Griot of Albuquerque, N.M.; Newport Corporation of Irvine, Calif., among others.

In some embodiments, one or more of these optical elements are operated to cause an optical beam to be swept through a portion of space, such as rotating a multifaceted mirror to cause an optical beam to scan across a surface. In some embodiments, the optical shaping component 616 includes one or more sensors 617 to detect the operational performance of one or more optical couplers or optical devices of the component 616, such as light detector to determine the characteristics of the optical beam traversing the component 616 or portions thereof or a motion detector to determine whether moving parts, if any, are performing properly. Any sensors known in the art may be used, such as a photocell, a bolometer, a thermocouple, temperature sensors, a pyro-electric sensor, a photo-transistor, a photo-resistor, a light emitting diode, a photodiode, a charge coupled device (CCD), a CMOS sensor, or a one or two dimensional array of CCDs or CMOS sensors or temperature sensors. In some embodiments, one or more of the optical components are provided by one or more micro-electrical-mechanical systems (MEMS).

The controller 618 controls operation of at least one of the power supply 612 or the light sources 614 or the optical shaping component 616. For example, the controller changes the power output of the power supply 612 to provide additional power when the barrier is to be on, and to conserve power when the barrier is to be off, e.g., according to a preset schedule or external input. In some embodiments, the controller receives data from one or more sensors 617 in the component 616, or environment sensor 619, and adjusts one or more controlling commands to the power supply 612, light source 614 or device of the component 616 in response to the output from the sensors. In some embodiments one or more feedback loops, interlocks, motion sensors, temperature sensors, light sensors are used, alone or in some combination. In some embodiments, the controller can be used to choose between different setups which define controlling schemes between different operation modes based on the input from the sensors or any input from the user. In some embodiments, the controller is used to drive any other devices which are synchronized with the optical barrier generator. Any device known in the art may be used as the controller, such as special purpose hardware like an application specific integrated circuit (ASIC) or a general purpose computer as depicted in FIG. 10 or a programmable chip set as depicted in FIG. 11 or mobile terminal as depicted in FIG. 12, all described in more detail in a later section.

The environment sensor 619 detects one or more environmental conditions, such as ambient light for one or more wavelengths or wavelength ranges in one or more directions, ambient noise for one or more acoustic frequencies or directions, temperature, temperature gradients in one or more directions, humidity, pressure, wind, chemical composition of air, movement of the ground or the environment, vibration, dust, fog, electric charge, magnetic fields or rainfall, among others, alone or in some combination. Any environment sensor known in the art may be used. There are a huge number of sensor vendors, including OMEGA Engineering of Stamford, Conn. In some embodiments, the environment sensor 619 is omitted. In embodiments that include the environment sensor 619, the controller 618 uses data from the environment sensor 619 to control the operation of one or more of the power supply 612, light source 615 or shaping component 616. For example, in some embodiments under conditions of high ambient light, light intensity output by the source 614 or component 616 is increased. As another example, in some embodiments under conditions of near 60% ambient humidity, optical shaping component 616 is adapted to reshape a beam to compensate for increased scattering.

In at least some states (e.g., during a scheduled period or in response to a value output by the environment sensor 619 falling within a predetermined range) or in response to acoustic tracking system 100 or identification system 200 or some combination, the barrier generator 610 produces an optical barrier 620. The optical barrier 620 comprises an optical waveform of sufficient power to perturb a pest and extends in a portion of space related to the generator 610. In some embodiments, the power of the waveform in the portion of space is limited by a maximum power, such as a maximum safe power for the one or more wavelengths of the optical waveform. For example, the illustrated optical barrier occupies a portion of space below the generator. The portion of space can be described as a thin sheet of height 626, width 624 and thickness 622, where thickness 622 represents the narrowest dimension of the barrier 620. Outside the optical barrier 620, the optical waveform, if present, is not sufficiently strong to adequately perturb a pest. In some embodiments, the optical barrier 620 is confined in one or more dimensions by walls or floor of a solid structure, or some combination. In some embodiments, the thin sheet barrier 620 is configured to cover an opening in a wall, such as a door or window.

Effective perturbation of a pest is illustrated in FIG. 6A as causing a pest to travel a pest track 630 that turns back rather than crosses the optical barrier 620. In some embodiments, effective perturbation of a pest includes immobilizing the pest or disabling or killing a living pest. Thus, the optical barrier generator 610 is configured to emit light of an optical waveform above a threshold power in a portion of space 620 positioned relative to the generator 610, wherein the particular optical waveform above the threshold power is effective at perturbing a pest to human activity. Pest perturbation is not observed in normal sunlight, which corresponds to visible light at power density levels below about 30 milliWatts per square centimeter, i.e., less than about 0.03 Watts per square centimeter (W/cm²). Perturbations were always observed at power density levels above about 6 W/cm².

In various other embodiments, the optical barrier occupies different portions of space relative to the generator, too numerous to illustrate. However, FIG. 6B and FIG. 6C depict two alternative portions of space to be occupied by optical barriers. FIG. 6B is a diagram that illustrates an example optical barrier 646, according to another embodiment. A hollow conical optical barrier 646 is generated below barrier generator 642 and surrounds conical protected volume 648. In some of these embodiments, the optical barrier 646 is produced by causing a narrow optical beam that produces an individual spot, such as spot 644, to sweep along a circular track on a horizontal surface below the barrier generator. The circular track is desirably circumscribed in a time short compared to the transit time of a pest through the beam that produces the spot 644.

FIG. 6C is a diagram that illustrates an example optical barrier 656, according to still another embodiment. In the illustrated embodiment, multiple barrier generators 652 surround an asset 660, such as a person, or a fixed asset such as a loading dock or pier, or a temporarily fixed asset such as a tent where one or more persons reside. Each barrier generator 652 generates a fan-shaped optical barrier 656. In the illustrated embodiment, each optical barrier 656 is a thin fan that covers an obtuse angle of about 120 degrees in one plane and sufficiently thick in a perpendicular plane (not shown) to perturb a pest. The distance of an outer edge of the barrier 656, e.g., an edge farthest from the barrier generator 652, is determined by attenuation or spreading of the light beam forming the barrier 656. In some embodiments, the optical barrier 656 is produced by causing a narrow optical beam, e.g., pencil beam 654, to sweep through the angular range about the barrier generator 652. The sweep is desirably completed in a time short compared to the transit time of a pest through the beam 654. The barrier generators 652 are spaced so that the fan shaped barrier of one generator 652 covers come or all of the space not covered by a fan of an adjacent barrier generator 652 to perturb pests that might otherwise reach asset 660.

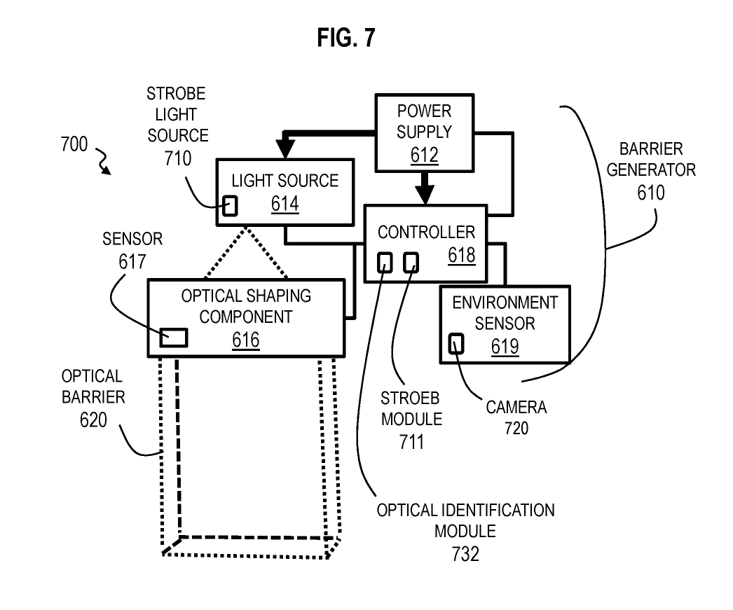

FIG. 7 is a block diagram that illustrates an example system 700 that integrates an identification system with an optical barrier to pests, according to an embodiment. In this embodiment, the controller 618 includes a strobe module 711 to control a strobe light source 710 and an optical identification module 732 that includes one or more portions of the identification module 232. The environmental sensor 619 includes a camera 720 and in some embodiments the optical filter to pass only the strobe light source wavelength. The monitored region 280 overlaps or includes the area of the optical barrier 620. In some embodiments, the light source 614 includes or is the same as the strobe light source 710. In some of these embodiments, the same light source is used in a low surveillance mode to determine whether there is an object in the region of the optical light barrier 620, uses a strobe mode and camera 720 to determine if the object is a pest to be blocked or repelled, and if so, provides the high intensity light to implement the light barrier 620. Smart trap features added to the light barrier insect defense technology can significantly enhance the effectivity and usefulness of the light barrier, for example helping them to switch-on when needed, know what they repelled, and learn when it is most important to apply defenses for what species in a local setting.

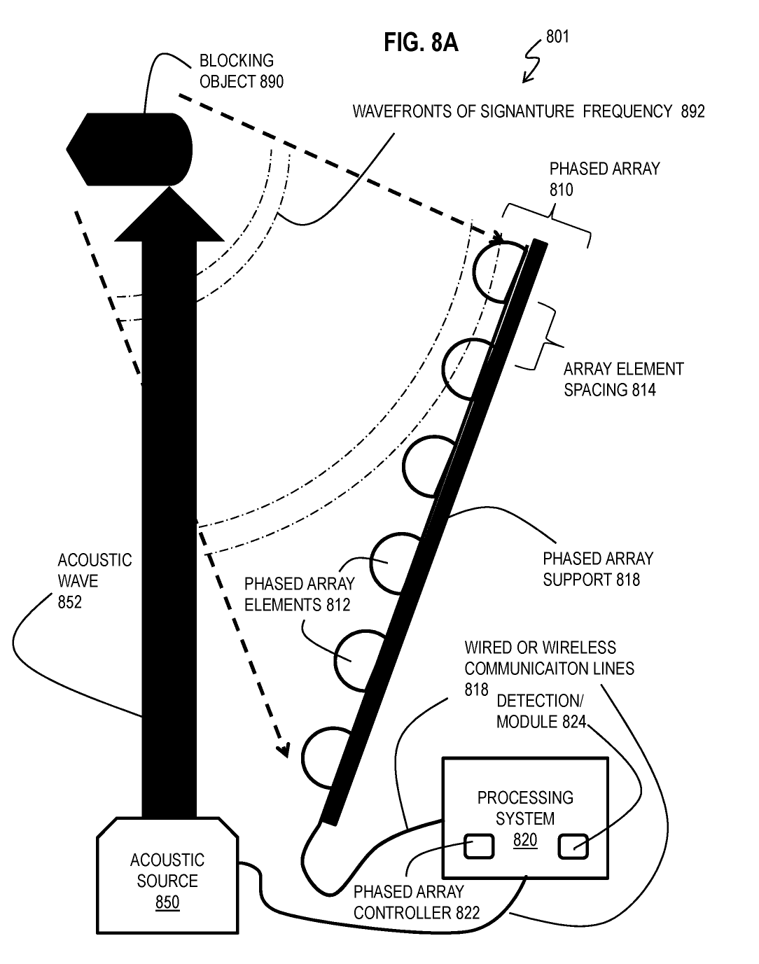

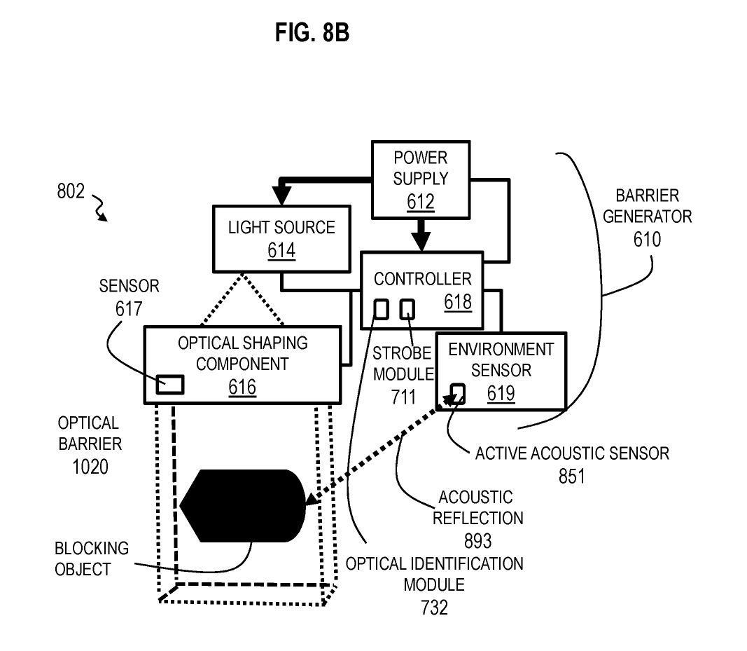

FIG. 8A is a block diagram that illustrates an example active acoustic detection of an object that blocks some remedial action, according to an embodiment. For example, a person or piece of furniture might be occupying the region where the light barrier 620 is to be enforced. Although blocking object 890 is depicted for the purposes of illustration, object 890 is not part of system 801. To detect a blocking object in some embodiments, an active acoustic detection system 801 is added to system 200. The active acoustic detection system 801 includes an acoustic source 850 which produces an acoustic waveform 853 which propagates through space to the monitored region. If it encounters a blocking object 890, the reflections at the frequency of the acoustic wave 852 are detected at one or more acoustic sensors, such as a microphone 110, microphone array, or a phased array 810. By determining the occurrence or direction of the reflected wave, the location of the blocking object can be determined. If it is located in the monitored region 280, then the system 200 is informed that the monitored region is blocked. In some embodiments, a movement of the blocking object is determined by a Doppler shift in the received acoustic frequency compared to the emitted acoustic frequency from source 850.

In an illustrated embodiment, a phased array 810a of multiple elements 812 are mounted to a support 818 and separated by a constant or variable array element spacing 814. Each element 810 is an omnidirectional or a directional microphone 110. An acoustic beam impinging on the phased array 810 at a particular angle will have acoustic wavefronts 892 that strikes the various elements with waveforms at successive times that depend on the sound speed, angle and spacing 814 blurred by the size of the swarm, the accuracy of the microphone locations and the accuracy of the microphone pointing directions. The wavelength and active acoustic frequency are related by the speed of sound in air which is a strong function of temperature, humidity and pressure, but is approximately 340 meters per second under some typical conditions. By combining the contributions at successive elements delayed by the time for an acoustic wavefront to arrive at those elements at a particular arrival angle for the local sound speed, the contributions from one direction can be distinguished from the arrivals at a different direction according to the well-known principles of beamforming. The time series of arrivals at each angle can be Fourier transformed to determine the spectral content of the arrival. Based on the spectral content, it can be determined whether the received frequency includes a reflected wave from the acoustic source 850 and whether the blocking object is moving.

Originally, the combination was performed by summing for hardware implementations where the search was implemented via wires and delay lines. Nowadays, digital phased array techniques are implemented as the processing is fast enough. For example an algorithm includes the following steps. The full data is recorded at each microphone (or sub array connected in hardware). The excess power algorithm outlined above is executed at each microphone to extract excess power based trigger of mosquito activity. If any of the detectors signals mosquito activity (usually the closest one) then the pairwise correlation between microphones are computed determining relative time delays and amplitude ratios between the sensing elements of the array. The information is combined either via trigonometry or the numerical approach e.g. the one outlined above to determine the 3D position of the emitter. Since each time slice gives a 3D position, the successive 3D positions provide a trajectory for a moving source or a successively refined position for a stationary source.

Processing system 820 includes a phased array controller module that is configured in hardware or software to do the beamforming on the arriving signals. The processing system 820 includes a detection module 824 that determines which direction is dominated by the acoustic signatures of a blocking object. Based on the direction from which the acoustic signatures of the blocking object, if any, are arriving, the module 824 informs the system 200 that the monitored region 280 is blocked. In some embodiments, the module 824 also issues an alert or alarm such as a flashing yellow light visible to a user, or a message to an operator. In some embodiments, the remedial device for which the remedial action is blocked, or the system 200, or some combination is deactivated until the blocking object moves or is removed.

In some embodiments the remedial action is to activate an optical barrier, as depicted in one of FIG. 6A through FIG. 6C. FIG. 8B is a block diagram that illustrates an example system that integrates a blocking detection system with an optical barrier to pests, according to an embodiment. In this embodiment, the system of FIG. 6A or of FIG. 7 is modified so that the environment sensor 619 includes an active acoustic sensor 851 that sends an active acoustic wave and detects any reflection 893. For example, in some embodiments, the sensor 851 incudes the acoustic source 850 and phased array 810 of FIG. 8A. Acoustically enhanced smart apertures based on multispectral stroboscopic imaging, low power computing core, and wireless communication can be used to retrofit and significantly enhance the utility of commercial traps with or without power (e.g. BGTraps™).

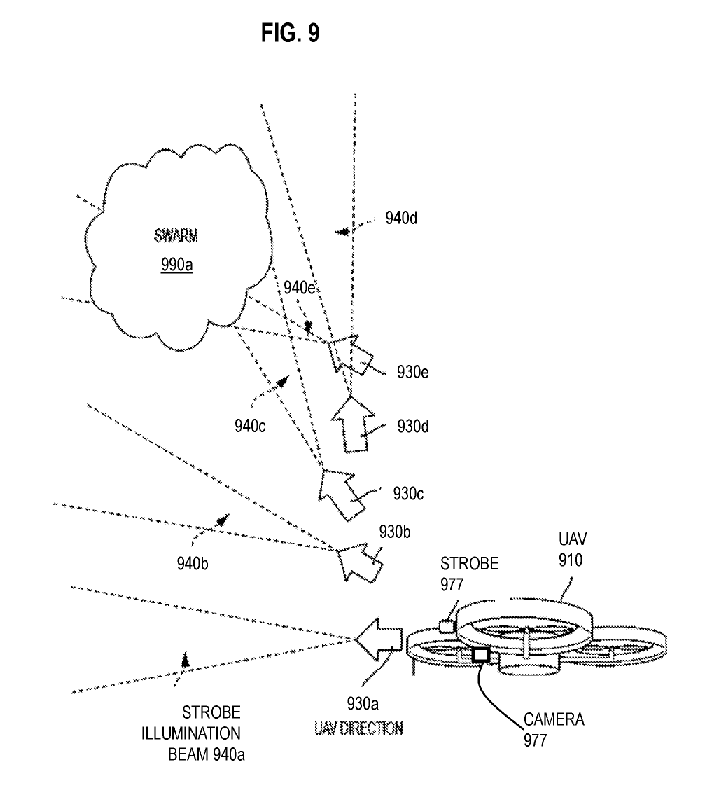

FIG. 9 is a block diagram that illustrates operation of an example identification system based on a UAV with an on board strobe and camera, according to another embodiment. Though depicted below the swarm 990a for purposes of illustration, in many embodiments, the UAV 910 is likely at a height of 3 to 5 meters above the ground and looking down on the layer of air where mosquito swarms are most probable. In other embodiments, the search and intercept is in the horizontal plane or in both vertical and horizontal planes. The same search principles apply as described next. In the depicted embodiment, one or more of a separate remote tracking system, identification system or remedial device is optional.

Initially, the UAV is moving in direction 930a with a forward looking monitored region 940a of a strobe illumination beam and field of view of camera 977. No signal of the target pest (e.g., swarm 990a) is detected. The UAV is then instructed (manually or by a search algorithm on a processor) to change direction (e.g., in the vertical plane as depicted in FIG. 9C), such that the UAV is headed in direction 930b and the monitored region 940b is directed upward. Again, no signal of the target pest is detected in the main lobe 940b. The UAV is then instructed to change direction again, such that the UAV is headed in direction 930c and the monitored region 940c is directed further upward. In this direction a signal of the target pest is detected in the monitored region 940c, and the UAV can use the information to identify the pest, based either on an on-board processing system or by sending the image to a remote controller and receiving instructions on how to proceed, e.g., to proceed in current direction 930c. In some embodiments, to make sure the UAV passes through the center of target pest, the UAV is again instructed to continue to change upward direction again, such that the UAV is headed in direction 930d and the monitored region 940d is directed further upward. In the illustrated embodiment, it is clear the direction has taken the UAV above the target pest, and the UAV is operated to reverses direction such that the UAV is headed in direction 930e. In this direction the m monitored region 940e is directed again toward the center of target pest swarm. These maneuvers can be repeated as the UAV continues to snake toward its target using its on-board strobe light and camera. In some embodiments, these maneuvers are controlled by a remote processor; but, in some embodiments, these corrective maneuvers are determined, in whole or in part, by a processor on board the UAV.

In an example embodiment, a PARROT AR.DRONE 2.0 from PARROT, INC.™ of San Francisco, Calif. was programed to maintain a small distance (about 1 meter) from a target comprising a blue and yellow target about the size of a soda can, in a complex city background scene. The drone demonstrated a maintained visual contact with the target within +/−10 degrees even for this small target. One can determine the momentary centroid of a target swarm better than 0.2 meters (m) in two dimensions, e.g., +/−1 degree from 6 meters away. The order of magnitude of a swarm's size is 1 meter, several times larger than the example embodiment target. This means that the swarm remains in the field of view of the camera even if the drone is 30 degrees away from the centroid at 4 meters away. The example programmed drone clearly performed sufficiently to meet the requirements posed by the camera and the swarm depicted in FIG. 9.

Automatized UAVs (unmanned aerial vehicles) equipped to image, characterize, identify and potentially selectively eradicate insects they encounter during their flight can cover significantly larger areas than other survey and trapping eradication methods, including state of the art trap networks. With additional acoustic tracking technology such UAV equipped with a smart aperture can also efficiently sample and kill swarming mosquito populations. It is also possible to place moving traps (i.e. UAVs retrofitted with traps) given smart aperture technology, such as system 500 depicted in FIG. 5, since the device can record the time and location of the capture. In the long run, if fast ‘onboard’ identification is achieved, intelligent collection via selective UAV interception or interdiction may also be implemented.

In a survey mode used in some embodiments, one or more UAVs are flying randomly or on a planned route and strobing the front below and/or above and seeing what insects they encounter. This is a very important replacement for traps in counting and population studies.

In some embodiments, UAVs, such as UAVs equipped with cameras or other sensing or surveillance equipment, or other vehicles, constitute a threat to the rights or welfare of persons or property. In these embodiments, the UAVs or other vehicles are themselves pests to be remediated.

In some embodiments, wearable global positioning system (GPS) or other location system enabled smart aperture technology detects, characterizes or identifies insects approaching a human or animal moving through a dwelling of interest. Such systems can provide unique data on disease vectors, exposure eventualities, and population in general that are not available for traditional trapping approaches. Such studies help homeowners, tenants and communities to get the chance for advanced warnings and targeted extermination.

Although processes, equipment, and data structures are depicted in FIG. 1 or FIG. 2, or FIG. 5, or FIG. 7 through FIG. 9 as integral blocks in a particular arrangement for purposes of illustration, in other embodiments one or more processes or data structures, or portions thereof, are arranged in a different manner, on the same or different hosts, in one or more databases, or are omitted, or one or more different processes or data structures are included on the same or different hosts.

FIG. 10 is a block diagram that illustrates a computer system 1000 upon which an embodiment of the invention may be implemented. Computer system 1000 includes a communication mechanism such as a bus 1010 for passing information between other internal and external components of the computer system 1000. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of one or more methods described herein.

A sequence of binary digits constitutes digital data that is used to represent a number or code for a character. A bus 1010 includes many parallel conductors of information so that information is transferred quickly among devices coupled to the bus 1010. One or more processors 1002 for processing information are coupled with the bus 1010. A processor 1002 performs a set of operations on information. The set of operations include bringing information in from the bus 1010 and placing information on the bus 1010. The set of operations also typically include comparing two or more units of information, shifting positions of units of information, and combining two or more units of information, such as by addition or multiplication. A sequence of operations to be executed by the processor 1002 constitutes computer instructions.

Computer system 1000 also includes a memory 1004 coupled to bus 1010. The memory 1004, such as a random access memory (RAM) or other dynamic storage device, stores information including computer instructions. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of computer instructions. The computer system 1000 also includes a read only memory (ROM) 1006 or other static storage device coupled to the bus 1010 for storing static information, including instructions, that is not changed by the computer system 1000. Also coupled to bus 1010 is a non-volatile (persistent) storage device 1008, such as a magnetic disk or optical disk, for storing information, including instructions, that persists even when the computer system 1000 is turned off or otherwise loses power.

Information, including instructions, is provided to the bus 1010 for use by the processor from an external input device 1012, such as a keyboard containing alphanumeric keys operated by a human user, or a sensor. A sensor detects conditions in its vicinity and transforms those detections into signals compatible with the signals used to represent information in computer system 1000. Other external devices coupled to bus 1010, used primarily for interacting with humans, include a display device 1014, such as a cathode ray tube (CRT) or a liquid crystal display (LCD), for presenting images, and a pointing device 1016, such as a mouse or a trackball or cursor direction keys, for controlling a position of a small cursor image presented on the display 1014 and issuing commands associated with graphical elements presented on the display 1014.

In the illustrated embodiment, special purpose hardware, such as an application specific integrated circuit (IC) 1020, is coupled to bus 1010. The special purpose hardware is configured to perform operations not performed by processor 1002 quickly enough for special purposes. Examples of application specific ICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 1070 sends and receives electrical, acoustic or electromagnetic signals, including infrared and optical signals, that carry information streams, such as digital data.

The term computer-readable medium is used herein to refer to any medium that participates in providing information to processor 1002, including instructions for execution. Such a medium may take many forms, including, but not limited to, non-volatile media, volatile media and transmission media. Non-volatile media include, for example, optical or magnetic disks, such as storage device 1008. Volatile media include, for example, dynamic memory 1004. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 1002, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 1002, except for carrier waves and other signals.

Logic encoded in one or more tangible media includes one or both of processor instructions on a computer-readable storage media and special purpose hardware, such as ASIC 1020.

Network link 1078 typically provides information communication through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090. A computer called a server 1092 connected to the Internet provides a service in response to information received over the Internet. For example, server 1092 provides information representing video data for presentation at display 1014.

The invention is related to the use of computer system 1000 for implementing the techniques described herein. According to one embodiment of the invention, those techniques are performed by computer system 1000 in response to processor 1002 executing one or more sequences of one or more instructions contained in memory 1004. Such instructions, also called software and program code, may be read into memory 1004 from another computer-readable medium such as storage device 1008. Execution of the sequences of instructions contained in memory 1004 causes processor 1002 to perform the method steps described herein. In alternative embodiments, hardware, such as application specific integrated circuit 1020, may be used in place of or in combination with software to implement the invention. Thus, embodiments of the invention are not limited to any specific combination of hardware and software.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server 1092 transmits program code for a particular application, requested by a message sent from computer 1000, through Internet 1090, ISP equipment 1084, local network 1080 and communications interface 1070. The received code may be executed by processor 1002 as it is received, or may be stored in storage device 1008 or other non-volatile storage for later execution, or both. In this manner, computer system 1000 may obtain application program code in the form of a signal on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red a carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set 1100 upon which an embodiment of the invention may be implemented. Chip set 1100 is programmed to perform one or more steps of a method described herein and includes, for instance, the processor and memory components described with respect to FIG. 15 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1100, or a portion thereof, constitutes a means for performing one or more steps of a method described herein.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 1105 also stores the data associated with or generated by the execution of one or more steps of the methods described herein.

FIG. 12 is a diagram of example components of a mobile terminal 1200 (e.g., cell phone handset) for communications, which is capable of operating in the system of FIG. 2C, according to one embodiment. In some embodiments, mobile terminal 1201, or a portion thereof, constitutes a means for performing one or more steps described herein. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps as described herein. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 as described herein. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

In some embodiments, the mobile terminal 1201 includes a digital camera comprising an array of optical detectors, such as charge coupled device (CCD) array 1265. The output of the array is image data that is transferred to the MCU for further processing or storage in the memory 1251 or both. In the illustrated embodiment, the light impinges on the optical array through a lens 1263, such as a pin-hole lens or a material lens made of an optical grade glass or plastic material. In the illustrated embodiment, the mobile terminal 1201 includes a light source 1261, such as a LED to illuminate a subject for capture by the optical array, e.g., CCD 1265. The light source is powered by the battery interface and power control module 1220 and controlled by the MCU 1203 based on instructions stored or loaded into the MCU 1203.

In some embodiments, the mobile terminal 1201 includes a data interface 1271 such as an USB port. Using the data interface 1271 digital metadata about the acoustic input or digital input (e.g., from a remote directional microphone) or digital output of a processing step is input to or output from the MCU 1203 of the mobile terminal 1201.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article. As used herein, unless otherwise clear from the context, a value is “about” another value if it is within a factor of two (twice or half) of the other value.

1. An system comprising:
a strobe light source;
a digital camera;
at least one processor; and
at least one memory including one or more sequences of instructions,
the at least one memory and the one or more sequences of instructions configured to, with the at least one processor, cause an apparatus to perform the steps of
identifying a pest type in a monitored region based on an image captured by the digital camera when the monitored region is illuminated by the strobe light source; and
operating a device based on the pest type identified.

2. A system as recited in claim 1, further comprising:
a remedial apparatus configured for remedial action;
wherein operating the device further comprises operating the remedial apparatus to direct remedial action against the identified pest.

3. A system as recited in claim 2, wherein the remedial apparatus comprises an optical barrier.

4. A system as recited in claim 2, wherein the remedial apparatus comprises a trap.

5. A system as recited in claim 2, wherein the remedial apparatus comprises a UAV.

6. A system as recited in claim 2, further comprising an active acoustic sensor wherein the apparatus is further caused to determine whether some remedial action is blocked.

7. A system as recited in claim 6, wherein the apparatus is further caused to determine whether an adjusted remedial action should be taken if it is determined that the remedial action is blocked.

8. A system as recited in claim 1, wherein the pest is a UAV.

9. A system as recited in claim 4, wherein the pest type is a bloodfed mosquito and the trap comprises a chamber with a blood testing device or a chamber with physical or chemical preservation that allows off-site testing or some combination.

10. A system as recited in claim 1, further comprising:
a passive acoustic system for tracking a pest;
the one or more sequences of instructions are further configured to cause the apparatus to perform the step of determining that the pest is in the monitored region based on the passive acoustic system before the strobe light and camera are operated for identifying the pest type.

11. A system as recited in claim 1, further comprising:
a refrigeration system for condensing carbon dioxide or human produced aromatic compounds out of the air into a reservoir;
a mechanism to release carbon dioxide or human produced aromatic compounds into the monitored region from the reservoir.
